(19) United States
(12) Patent Application Publication
(10) Pub. No.: US 2011/0298187 A1
(43) Pub. Date: Dec. 8, 2011

(54) Dust repelling tool brake, tool insert part, tool mount, machine tool

(76) Inventors: Rainer Ontl, Landsberg am Lech (DE); Christoph Dieing, Isny (DE); Christian Rehekampff, Kaufering (DE); Damir Cehajic, Durach (DE)

(21) Appl. No.: 13/151,569

(22) Filed: Jun. 2, 2011

(30) Foreign Application Priority Data
Jun. 2, 2010 (DE) 102010029609.0

(51) Int. Cl. B25D 17/08; B23B 31/02; B25F 5/00

(52) U.S. Cl. 279/43.9; 173/210; 173/114

(57) ABSTRACT

A dust-repelling tool brake is provided for a friction-fitting holding of a tool in the tool brake. The tool brake is provided in the form of an annular cap for deterring dust with an insert opening for an axial mount for the tool. It is provided that an insert ring arranged in the annular cap surrounds an annular section of the annular cap initially limiting the insert opening.

### RELATED APPLICATIONS

The present application claims priority to German Patent Application DE 10 2010 029 609.0, filed Jun. 2, 2010, and entitled “DUST REPELLING TOOL BRAKE, TOOL INSERT PART, TOOL MOUNT, MACHINE TOOL” the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a dust-repelling tool brake and a tool insert part.

DE 10 2007 000 453 A1 discloses a tool mount, which is also known to the applicant as a click-tool mount. Here, a tool can be mounted in the axial mount of the tool-guiding basic body. The tool can be locked in a suitable position by a latch element of the sheath arrangement encompassing the basic body. Here, the latch element engages an allocated recess of the tool. The tool can be inserted into the axial mount by a tool insert part of the type mentioned at the outset. The tool insert part is held at the basic body and the sheath arrangement according to DE 10 2007 000 453 A1 and can alternately be attached and detached.

In DE 10 2005 000 168 A1, a tool insert part of the type mentioned at the outset is described within the scope of a tool mount, comprising an insert opening for an axial mount, which is limited by an annular cap held at the tool insert part in order to repel dust. Such a dust repellent serves to protect the tool mount from the penetration of dust or a similar milling substance, which develops during the processing of material, such as by way of drilling, chiseling, hammering, and the like.

In a machine tool, such tool mounts serve to hold a tool, for example a drill bit or a chisel. A machine tool is particularly designed to function as a hammer drill, a chisel drill, or a similarly multi-purpose machine drill. In such machine tools, and others, the tool can be impacted at least partially with a hammering motion. For this purpose, the machine tool comprises a hammer mechanism—be it a mechanical or a pneumatic hammer mechanism. It has been observed that at the end of a material processing procedure—particularly during the removal of the machine tool with the tool from the underground—the hammer mechanism can unintentionally be reactivated by a so-called restriking, so that the tool is once more set into a hammering motion although the processing procedure should have ended. Furthermore, the problem arises that during the restriking of the tool, the tool mount or even the machine tool may become damaged so that the overall life of the machine tool is shortened.

A machine tool would be desirable in which the restriking of a tool is prevented or at least reduced. Solutions of prior art have shown to be in need of improvement.

### BRIEF SUMMARY OF THE INVENTION

Embodiments of the present invention provide a dust-repelling tool brake. The tool brake provides an annular cap for repelling dust. The annular cap has an insert opening that opens to an axial mount for a tool in a tool insert part. The tool brake provides for friction-fitting holding of the tool. Embodiments of the present invention relate to a tool insert part mounted in an interchangeable fashion at a tool mount, having an axial mount for a tool for a machine tool. The machine tool has a hammer mechanism by which an at least partially striking motion of the tool can be impinged in the axial mount with the tool insert part. Certain embodiments of the present invention also relate to a tool mount having an axial mount for a tool for a machine tool with a hammer mechanism, by which an at least partially hammering motion of the tool can be applied in the axial mount, with the tool mount comprising: a basic body with the axial mount, and a sheath arrangement, at least partially encompassing the basic body, having at least one latch element for locking the tool to the basic body and a tool insert part at the tool side comprising an insert opening for an axial mount, which is limited by an annular cap, held at a tool insert part, in order to repel dust. Certain embodiments of the present invention also relate to a machine tool comprising such a tool mount.

An objective of embodiments of the present invention is to provide a dust repellent, a tool insert part, a tool mount, and a machine tool by which the restriking of a tool can at least be reduced. In particular, a dust repellent, a tool insert part, a tool mount, and/or a machine tool may be embodied such that they develop suitable braking effects in reference to a tool, so that a restriking of the tool is at least reduced. In particular, a braking effect may be created upon the tool during the completion of a processing procedure, particularly when lifting the machine tool after the processing procedure.

According to embodiment of the present invention, an objective regarding the dust repellent and the tool insert part is attained via a dust repellent and a tool insert part of the type mentioned at the outset, in which it is provided according to aspects of the present invention that an insert ring arranged in the annular cap encompasses an annular section of the annular cap initially limiting the insert opening.

Accordingly, a tool insert part is embodied as a part of the tool mount according to aspects of the present invention.

Embodiments of the present invention also provide a machine tool with a tool mount of the above-mentioned type, wherein the machine tool comprises a hammer mechanism by which a tool can be impacted with an at least partially hammering motion.

Aspects of the present invention are based on the idea that at the end of a processing procedure, i.e. particularly when lifting the machine tool with the tool off the underground to be processed, the tool should be held in a frontal position. Holding the tool in its frontal position regularly prevents the restriking of the tool. This allows for the prevention of the hammer mechanism's reaching a new operating site and being reactivated due to a rebounding tool.

Aspects of the present invention recognize that a measure wherein the tool is held in a frontal position can best be realized in a dust repellent and/or in a tool insert part, namely, according to aspects of the present invention, through the further development of a dust repelling annular cap of a tool brake, held at the tool insert part and known per se. Aspects of the present invention recognize that the annular cap for repelling dust can be further developed with an insert ring arranged at the annular cap, which encompasses one of the annular sections of the annular cap initially limiting the insert opening.

In embodiments of the present invention, the annular section of the annular cap is embodied, under reinforcement by the insert ring, such that the insert opening is sufficiently limited to hold a tool in the frontal position at the end of a processing procedure. The concept of aspects of the present invention allows for a holding of the tool in a frontal position by way of friction-fitting at the end of a processing procedure. Aspects of the present invention recognize that an insert opening tightly limiting the tool by the annular section acts in a dust-repelling fashion and thus already surrounds the tool relatively tightly. By inserting an insert ring into the annular cap, the annular section limiting the insert opening is embodied such that, at the end of the processing procedure, the initially merely dust-proof limiting of the insert opening now also acts in a sufficiently friction-fitting fashion upon the tool to hold it in the frontal position.

Aspects of the concept of the present invention have proven to be relatively effective and yet easily realized in reference to measures known from prior art.

Advantageous further developments of aspects of the present invention are discernible, for example, from the dependent claims and show individual advantageous ways to implement the above-explained concepts within the scope of the objective as well as with regard to additional advantages.

A particular advantage of embodiments of the present invention is that the insert ring, on the one hand, and at least the annular section of the annular cap, on the other hand, show an expansion behavior under the influence of heat such that a cross-section of the insert opening is smaller under the influence of heat than without the influence of heat. Advantageously, during the processing procedure—i.e. through a hammering or striking motion of the tool, potentially also by a rotary motion of the tool—heat is created at the annular section, which under the influence of the insert ring serves to reduce the cross-section of the insert opening. This results in an increased friction effect upon a tool, which can hold said tool effectively in its frontal position, but in any case also brakes it. The friction effect is sufficient to hold the tool in its frontal position in a friction-fitting manner or to brake a tool that is striking back to such an extent that it does not undesirably activate the hammer mechanism. Overall it has been shown that a cross-section of the insert opening under the influence of heat, i.e. usually after the end of the processing procedure, is smaller compared to a situation without the influence of heat. Under the influence of heat, a tool can be held directly or indirectly at the annular section of the annular cap in a friction-fitting fashion. In general, it is preferable that the annular section of the annular cap directly limit the insert opening. However, it is also possible for the annular section of the annular cap to limit the insert opening only indirectly—for example, by encompassing another annular part—preferably increasing the friction effect.

In particular, embodiments of the present invention provide that the annular section of the annular cap, for example the entire annular cap, on the one hand, and the insert ring on the other hand, are made from materials with different thermal expansion coefficients and/or strengths. In particular, a heat expansion coefficient of the insert ring may be lower than the one of the annular section, for example the one of the annular cap. In particular the strength of the insert ring may be higher than the one of the annular section, for example the one of the annular cap. Both measures, individually as well as in combination—particularly with a reduced cross-section of an insert opening—allow for the holding of a tool in the frontal position in a friction-fitting manner, or for braking it, at the end of a processing procedure. The annular cap is preferably embodied from plastic, particularly from an elastomer or a similar material showing good heat expansion. The insert ring is preferably made from steel or a material of similar tensile strength and stability as well as heat-expansion properties, compared to the annular section of the annular cap. Consequently, the above-mentioned further developments—individually or in combination—according to the concept of aspects of the present invention provide that the annular section of the annular cap, due to the expandability being limited towards the outside by the insert ring, is smaller at the end of a processing procedure. This way, the annular cap according to aspects of the invention acts as a tool brake.

Within the scope of a particularly preferred further embodiment the annular cap provides a groove at the side of the tool, open for an axial mount. It serves to improve the dust-repelling effect of the tool brake. The annular section is preferably arranged in the axial direction at the machine side of the open groove. Therefore, the tool insert part offers a sufficiently large friction-fitting holding surface for the tool.

The annular cap preferably comprises an annular flange, held in an insert groove of the tool insert part. This way, the annular cap can be mounted to the tool insert part in a particularly secure fashion. The insert ring is arranged in a particularly preferred fashion axially at the height of the annular flange. The insert ring, aligned this way radially between the annular section and the annular flange, is arranged particularly securely in the tool insert part and increases at this point the effect of aspects of the concept of the invention. An insert groove of the tool insert part is preferably arranged in a surface of the annular cap facing a machine tool. The insert ring is thus protected from external influences and additionally, in combination with the annular section, particularly under the influence of heat, it can develop a particularly strong friction-fitting holding effect upon a tool after a processing procedure has ended.

In the following, exemplary embodiments according to aspects of the present invention are explained using the drawings. The figures show exemplary embodiments, not necessarily according to scale, but rather the figures are embodied to serve as an explanation, in a schematic and/or slightly distorted form. Reference is made to prior art with regard to modification of the teaching immediately discernible from the figures. Here, it must be considered that multiple modifications and changes can be made with regard to the form and the detail of an exemplary embodiment, without deviating from the general idea of the invention. The features of the invention disclosed in the description, the figures, as well as the claims, both individually as well as in any arbitrary combination, may be essential for the further development of the invention. Additionally, the scope of the invention also includes all combinations of at least two of the features disclosed in the description, the figures, and/or the claims. The general idea of the invention is not limited to the exact shape or the detail of the preferred exemplary embodiments shown in the following and described or limited to an object restricted in reference to the object claimed in the claims. When measurement ranges are stated, limits disclosed within the values mentioned shall be considered guidelines and used arbitrarily. For reasons of simplicity, identical or similar parts or parts with an identical or similar function are marked with the same reference numeral.

### BRIEF DESCRIPTION OF THE FIGURES

Additional advantages, features, and details of the invention are discernible from the following description of the preferred exemplary embodiments as well as the drawing. in which:

FIG. 1 shows a perspective cross-section of a tool mount of a particularly preferred exemplary embodiment with a tool insert part according to an embodiment of the present invention;

FIG. 2 shows a tool insert part of FIG. 1 in an enlarged, perspective cross-section;

FIG. 3 shows a perspective partial cross-section of a frontal area of a machine tool with a hammer mechanism, not shown in greater detail, mounted at the same tool mount as in FIG. 1 as well as with a tool in the form of a percussion drill in the tool mount.

### DETAILED DESCRIPTION OF THE INVENTION

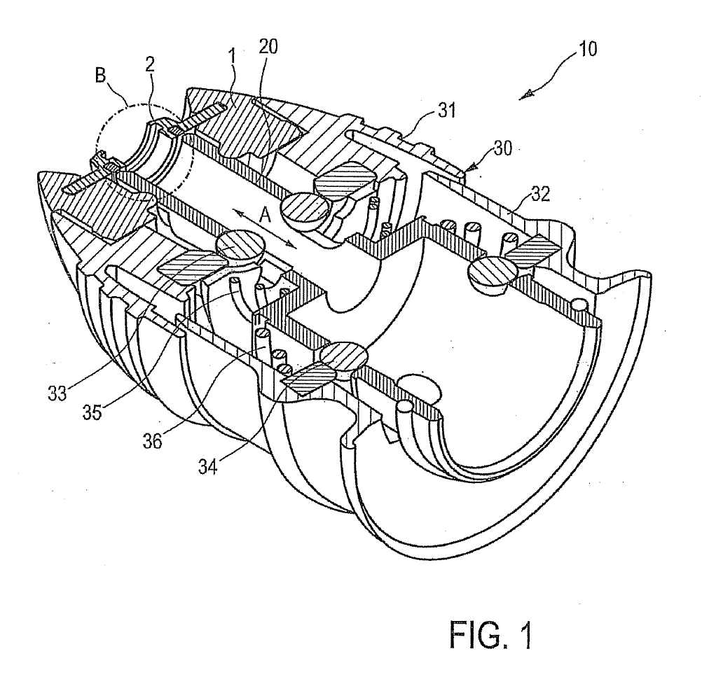

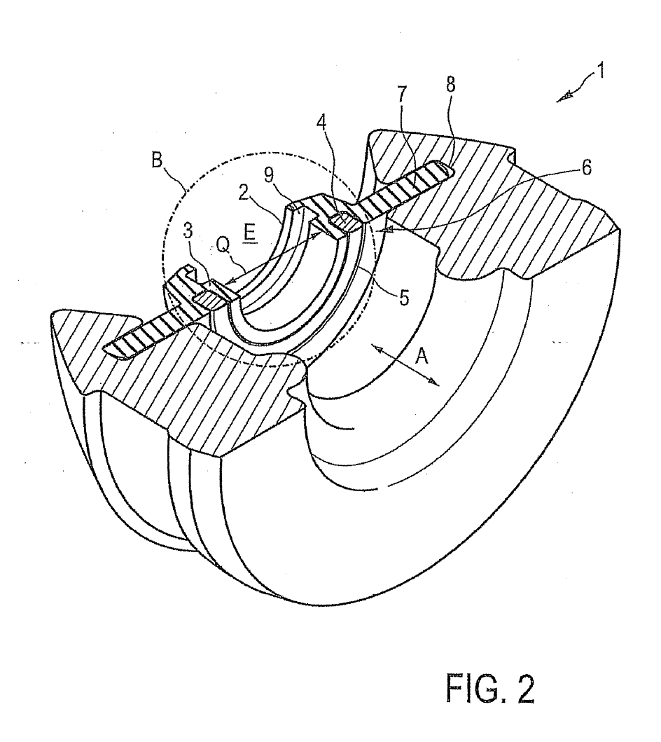

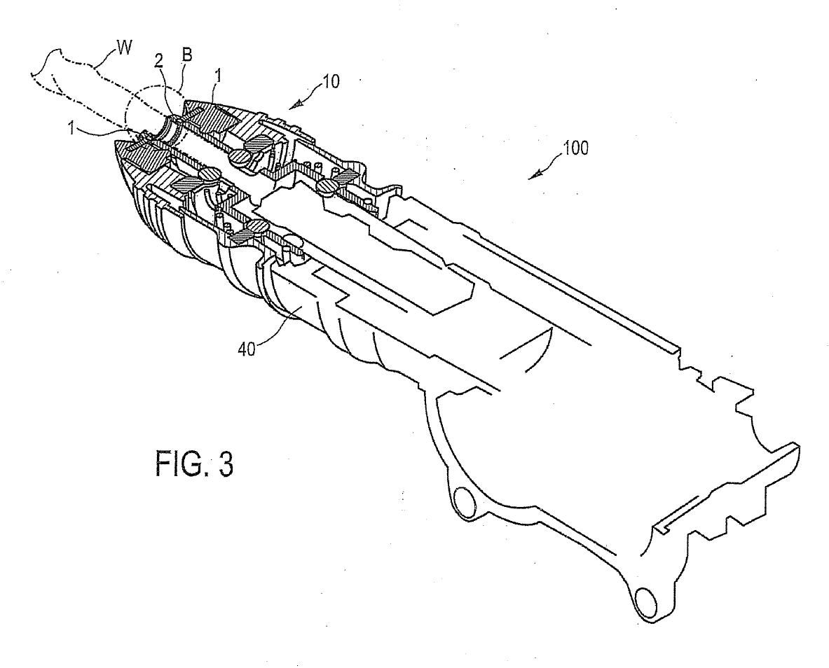

FIG. 1 shows a tool mount 10 for a machine tool 100, explained in greater detail in reference to FIG. 3, having a tool inset part 1 shown enlarged in reference to FIG. 2.

The tool mount 10 comprises an axial mount A for a tool W (shown in FIG. 3). The axial mount A serving as the tool guide is formed by a basic body 20. The basic body 20 is arranged here inside a sheath arrangement 30, which serves to manually perform the exchange of the tool W. For this purpose, the sheath arrangement 30 is provided here with at least one latch element 33, 34, here as a ball each, by which the tool can be locked and/or released in the basic body 20. In detail, the sheath arrangement 30 first comprises a latching sheath 31 with in the illustrated case two spherical latch elements 33, which are embodied to engage an allocated recess of the tool W, not shown in greater detail. The latch elements 33 engage the basic body 20 through an opening, not marked in greater detail. Furthermore, the sheath arrangement 30 comprises an engagement sheath 32 at the machine side. The latching sheath 31 can be offset towards the engagement sheath 32 against a spring 35. By pulling the latching sheath 31 against the spring force of the spring 35 the latching elements 33 are released from the tool W and the tool can be removed from the axial mount A and/or inserted therein. The engagement sheath 32 is fixed via another spring 36 and the latching elements 34 at the basic body 20. The tool mount 10 embodied in this manner is provided with the tool inset part 1, shown enlarged in FIG. 2, and the tool brake B embodied thereat. During operation, the tool mount will be mounted at a transmission part 40 of the machine tool 100 of FIG. 3, not explained in greater detail here, provided with a hammer mechanism. The system of the machine tool 100 formed in this way with the tool W, tool insert part 1, tool mount 10, and transmission part 40 can overall be disassembled. In particular, the tool insert part 1 can be manually exchanged and mounted at the tool mount 10. Similarly, the tool mount 10 can be manually interchangeably fastened at the transmission part 40.

In the following, with reference to FIG. 2, the tool insert part 1 is described, essentially embodied in a cylindrical fashion. Said part is penetrated by an axial mount A and offers an insert opening E for an axial mount A. The insert opening E is radially limited by an annular cap 2 held at the tool insert part. Here, the annular cap 2 serves as a dust repellent in order to prevent, or at least to reduce the penetration of dust or similar milling material, which develops during the processing of material by the tool, into the tool mount 10. In detail, the insert opening E shows a cross-section marked Q, which is framed by an annular section 3 immediately limiting the insert opening E and formed at the annular cap 2. The annular section 3 of the annular cap 2 is surrounded by an insert ring 4 according to aspects of the concept of the present invention. The insert ring 4 is arranged in an insert groove 5 surrounding the annular section 3. The insert groove 5 extends into an area 6 of the annular cap 2 facing the machine tool 100. In other words, the insert groove 5 is arranged on an area 6 facing away from the processing section of the tool W. The area 6 continues in an annular flange 7, expanding the annular cap 2 radially outward and extending into a flange groove 8 of the body of the tool insert part 1. This way, the annular cap 2 is held securely in the body of the tool insert part 1. A worn annular cap 2 can be pulled out of the flange groove 8 and replaced by a new annular cap 2. Furthermore, the insert ring 4 is arranged in the insert groove 5 aligned in the radial direction to the annular section 3 and the annular flange 7. In other words, the annular section 3, the insert groove 5, and the insert ring 4 as well as the annular flange 7 are formed in a level perpendicular in reference to the axial mount A and thus arranged in the tool guide part 1.

Furthermore, the insert ring 4 is set back from the frontal area of the annular cap 2, facing the processing section of the tool W, and also set back from a groove 9 of the annular cap 2 open towards the axial mount A. In other words, the annular section 3 is arranged at the side of the groove 9 open towards the machine. The annular section 3, set back in reference to the open groove 9, is therefore protected from dust which can be collected in the open groove 9. Furthermore, the annular section 3, together with the open groove 9, offers sufficient interior holding surface for holding the tool in a frontal position when a processing procedure has ended.

The effect of the annular cap 2 of the so-called tool brake B develops as follows. During the processing of the material the tool W is at least partially moved striking in the axial mount A and friction-gliding at the interior surface of the annular section 3 of the annular cap 2. The heat developing here leads to thermal influence acting upon the entire annular cap 2, leading to all parts of the annular cap 2 showing an expansion behavior. This thermal influence is also present directly after the end of the processing procedure. Additionally, the thermal influence leads to the thermal expansion behavior of the annular section 3 being greater than a thermal expansion behavior of the insert ring 4. Consequently a thermal expansion behavior of the annular section 3 is limited by the insert ring 4 radially outward such that the annular section 3 increasingly expands into the insert opening E. This leads to an effective reduction of the cross-section Q of the insert opening E, which is sufficiently narrowed at the end of the processing procedure to hold or brake a tool W in a friction-fitting manner in its frontal position in the axial mount A of the annular cap 2, i.e. friction-fitting at the annular section 3. On the one hand, the friction-fitting force created here is harmless during the processing motion of the tool, regardless of a rotary motion for drilling or an additional or alternative striking motion. On the other hand, when a processing procedure has ended, particularly when the machine tool with the tool is lifted off the underground, the tool W striking forward out of the axial mount A is held or braked in the frontal position, namely by the friction force created in the tool brake B. A particularly high friction-fitting force is achieved here by an annular cap 2 made from an elastomer plastic and an insert ring 4 made from steel.

1. A dust-repelling tool brake for friction-fitting holding of a tool, the tool brake in the form of an annular cap for repelling dust, having an insert opening to an axial mount for the tool in a tool insert part in the tool brake, the tool brake comprising:
an insert ring arranged in the annular cap, the annular cap having a ring section initially limiting the insert opening, the insert ring encompassing the ring section of the annular cap.

2. A tool insert part, for mounting in an interchangeable fashion at a tool mount, having an axial mount for a tool for a machine tool, the machine tool having a hammer mechanism by which an at least partially striking motion of the tool can be impinged in the axial mount, the tool insert part comprising:
an insert opening for the axial mount;
an annular cap held by the tool insert part to repel dust, the annular cap comprising an annular section initially limiting the insert opening; and
an insert ring arranged in the annular cap, the insert ring encompassing the annular section of the annular cap initially limiting the insert opening.

3. A tool insert part according to claim 2, wherein the insert ring and at least the annular section of the annular cap show an expansion behavior under the influence of heat, such that a cross-section of the insert opening is smaller under the influence of heat than without the influence of heat.

4. A tool insert part according to claim 2, wherein a cross-section of the insert opening is smaller under the influence of heat than without the influence of heat, such that the tool mounted via the axial mount is held by the annular section of the annular cap in a friction-fitting fashion when under the influence of heat.

5. A tool insert part according to claim 2, wherein at least the annular section of the annular cap and the insert ring are made from materials with different at least one of thermal expansion coefficient and strength.

6. A tool insert part according to claim 2, wherein a thermal expansion coefficient of the insert ring is lower than that of the annular section of the annular cap.

7. A tool insert part according to claim 2, wherein a strength of the insert ring is higher than that of the annular section of the annular cap.

8. A tool insert part according to claim 2, wherein the annular cap is made from an elastomer.

9. A tool insert part according to claim 2, wherein the insert ring is made from steel.

10. A tool insert part according to claim 2, wherein the annular section of the annular cap surrounds the insert opening in a directly limiting fashion.

11. A tool insert part according to claim 2, wherein the annular cap comprises a groove open towards the axial mount, and the annular section is arranged at the machine tool side of the open groove.

12. A tool insert part according to claim 2, comprising a flange groove, wherein the annular cap comprises an annular flange, the annular flange held in the flange groove of the tool insert part, the insert ring being arranged axially at the height of the annular flange.

13. A tool insert part according to claim 2, comprising an insert groove for the insert ring, the insert groove arranged in an area of the annular cap facing the machine tool.

14. A tool mount with an axial mount for a tool for a machine tool, the machine tool having a hammer mechanism by which an at least partially striking motion of the tool can be applied in the axial mount, the tool mount comprising:
a basic body comprising the axial mount;
a sheath arrangement surrounding the basic body at least partially, the sheath arrangement comprising at least one latch element for locking the tool to the basic body; and
a tool insert part, the tool insert part comprising:
an insert opening for the axial mount;
an annular cap held by the tool insert part to repel dust, the annular cap comprising an annular section initially limiting the insert opening; and
an insert ring arranged in the annular cap, the insert ring surrounding the annular section of the annular cap initially limiting the insert opening.

15. A tool mount according to claim 14, wherein, at least under the influence of heat, the tool can be held in a friction-fitting manner in the annular section of the annular cap of the tool insert part.

16. A tool mount according to claim 14, wherein the insert ring and at least the annular section of the annular cap show an expansion behavior under the influence of heat, such that a cross-section of the insert opening is smaller under the influence of heat than without the influence of heat.

17. A tool mount according to claim 14, wherein a thermal expansion coefficient of the insert ring is lower than that of the annular section of the annular cap.

18. A tool mount according to claim 14, wherein the annular section of the annular cap surrounds the insert opening in a directly limiting fashion.

19. A tool mount according to claim 14, wherein the tool insert part comprises a flange groove, wherein the annular cap comprises an annular flange, the annular flange held in the flange groove of the tool insert part, the insert ring being arranged axially at the height of the annular flange.

20. A tool mount according to claim 14, wherein the tool insert part comprises an insert groove for the insert ring, the insert groove arranged in an area of the annular cap facing the machine tool.
